(19) United States
(12) Patent Application Publication
(10) Pub. No.: US 2006/0149823 A1
(43) Pub. Date: Jul. 6, 2006

(54) Electronic mail system and method

(75) Inventors: Brad Owen, Mesa, AZ (US); Jason Steiner, Glendale, AZ (US)

Correspondence Address: GO DADDY GROUP, INC., 14455 NORTH HAYDEN ROAD, SUITE 219, SCOTTSDALE, AZ, 85260, US

(73) Assignee: The Go Daddy Group, Inc, Scottsdale, AZ (US)

(21) Appl. No.: 11/030,612

(22) Filed: Jan. 6, 2005

(51) Int. Cl. G06F 15/16

(52) U.S. Cl. 709/206

(57) ABSTRACT

Systems and methods of the present invention allow a Sender of an email message to log email message attributes in an email database. An email filter located between the Sender and a Recipient of the email message may access the database and verify if the email message truly originated from the Sender. The email filter may route the email message based on the status of the email message attributes stored at the email database. Such routing includes delivering the email message to the Recipient, delivering the message to a Quarantine Mailbox, or deleting the message.

### FIELD OF THE INVENTION

The present invention relates in general to electronic mail systems and methods and in particular to systems and methods for filtering email messages, email delivery confirmations, and email message integrity.

### BACKGROUND OF THE INVENTION

Users of computer networks, such as corporate networks or the Internet, routinely send electronic messages to each other. Electronic messages may contain, for example, text, images, links, and attachments. Electronic mail or email is one of the most widely used methods of communication over the Internet due to the variety of data that may be transmitted, the large number of available recipients, speed, low cost and convenience.

Email messages may be sent, for example, between friends, family members or between coworkers thereby substituting for traditional letters and office correspondences in many cases. This is made possible because the Internet has very few restrictions on who may send emails, the number of emails that may be transmitted and who may receive the emails. The only real hurdle for sending emails is the requirement that the sender must know the email address (also called network mailbox) of the intended recipient.

Email messages travel across the Internet, typically passing from server to server, at amazing speeds achievable only by electronic data. The Internet provides the ability to send an email anywhere in the world, often in less than a few seconds. Delivery times are continually being reduced as the Internet's ability to transfer electronic data improves.

Most Internet users find emails to be much more convenient than traditional mail. Traditional mail requires stamps and envelopes to be purchased and a supply maintained, while emails do not require the costs and burden of maintaining a supply of associated products. Emails may also be sent with the click of a few buttons, while letters typically need to be transported to a physical location, such as a mail box, before being sent.

Once a computer and a network connection have been obtained, there are typically few additional costs associated with sending emails. This remains true even if millions, or more, of emails are sent by the same user. Emails thus have the extraordinary power of allowing a single user to send one or more messages to a very large number of people at an extremely low cost.

The Internet has become a very valuable tool for business and personal communications, information sharing, commerce, etc. However, some individuals have abused the Internet. Among such abuses are spam and phishing. Spam, or unsolicited email, is the flooding of the Internet with many copies of the identical or nearly identical message, in an attempt to force the message on people who would not otherwise choose to receive it. Most spam is commercial advertising, often for dubious products, get-rich-quick schemes, or financial or quasi-legal services.

A single spam message received by a user uses only a small amount of the user's email account's allotted disk space, requires relatively little time to delete and does little to obscure the messages desired by the user. Even a small number of spam messages, while still annoying, would nonetheless cause relatively few real problems. However, the amount of spam transmitted over the Internet is growing at an alarming rate. While a single or small number of spam messages are annoying, a large number of spam can fill a user's email account's allotted disk space thereby preventing the receipt of desired email. Also, a large number of spam can take a significant amount of time to delete and can even obscure the presence of desired emails in the user's email account.

Spam messages currently comprise such a large portion of Internet communications that they actually cause data transmission problems for the Internet as a whole. Spam creates data log jams thereby slowing the delivery of more desired data through the Internet. The larger volume of data created by spam also requires Internet providers to buy larger and more powerful (i.e. more expensive) equipment to handle the additional data flow caused by the spam.

Spam has a very poor response rate compared to other forms of advertisement. However, since almost all of the costs/problems for transmitting and receiving spam are absorbed by the recipient of the spam and the providers of the Internet infrastructure, spam nevertheless continues to be commercially viable for a spammer.

Phishing is the luring of sensitive information, such as passwords, credit card numbers, bank accounts and other personal information, from an Internet user by masquerading as someone trustworthy with a legitimate need for such information. Often phishing goes hand-in-hand with spam. The perpetrators send out a large number of email messages to lure as many people as they can to their phishing “nets”. Typically, if a user clicks on the link in the email, it takes the user to a webpage that appears very similar to a business that the user might trust. However, this webpage is controlled by the perpetrators and any information entered on the webpage will be forwarded to the perpetrators. The perpetrators may use users' information to commit fraud or other crimes. Often users' information is used for identity theft crimes.

If the user is able to see the URL address of the phishing webpage, the user may realize that it does not belong to a business that the user trusts. Phishers use various techniques to disguise their URL addresses. Among such techniques is hiding the true URL address in the phishing email behind some text, an address of a reputable business, or an image; removing the address bar in the Internet browser; replacing the address bar of the Internet browser with a fake address bar; using IP (Internet Protocol) numbers instead of a domain name in the URL; using domain names that are similar in spelling to the domain names of the reputable businesses; using extremely long URL addresses that the beginning of the address would not be plainly visible in the address bar of the Internet browser; etc. Also, long URL addresses may be harder to analyze, thus further helping the perpetrators in obscuring the true location of their phishing webpages.

There are various techniques used for combating spam and phishing. Among them are spam filtering, email challenge-response systems, maintaining white and/or black lists for email addresses, domain names, and IP numbers, Internet browser add-ons that show the true location of the pages viewed by the user, etc.

For many email filtering systems to work properly, the sender's email address or at least its domain name part should be correct. Often malicious users forge (spoof) the sender's email address when they send out spam, viruses, or phishing email messages.

Even though multiple systems are being used, the amount of spam, phishing, and other Internet abuses is steadily rising. The existing systems identify the trust level of the email senders or analyze the content of the email message. However, an email sender may forge its true identity, use a temporary email account, use an open relay IP to send email messages, or use somebody else's computer to send messages if virus or spy software was installed. Also senders of spam and phishing attacks may provide email message content that is not related to the content of the links embedded in the email or they may use content that looks absolutely legitimate. All of these make it very hard to keep track of email addresses and originating IP addresses, as well as filtering messages based on their content.

Therefore, new systems and methods are needed to overcome the limitations of the current systems and methods. It is desired to create systems and methods that provide more efficient solutions for combating Internet abuses, such as spam and phishing.

### SUMMARY OF THE INVENTION

The limitations cited above and others are substantially overcome through one or more of the systems and methods disclosed herein. The systems and methods allow for more efficient email filtering, email delivery confirmations, and email message integrity.

One of the embodiments of the invention discloses a system that allows for checking if an email message truly originated from the purported email address. The system may comprise a Sender, a Recipient, an Email Filter, a Server, and an Email Database. The system may also include a Quarantine Mailbox. In this embodiment, the Sender sends an email message to the Recipient and logs email message attributes in the Email Database. Typically, the Sender needs to be authenticated by the Email Database or the Server to be able to log the email message attributes in the Email Database. The Email Filter intercepts the message and verifies the email message attributes in the Email Database through the Server. If the email message attributes are found in the Email Database, it indicates that the message truly originated from the Sender. If the attributes are verified, the Email Filter may deliver the email message to the Recipient. If the attributes are not verified, the Email Filter may delete the message or route it to the Quarantine Mailbox.

In an embodiment of the process of the present invention an Email Filter may receive an email message. The Email Filter may send a request to a Server providing information related to the email message. The Email Filter may receive a response from the Server indicating whether the email message was logged into an Email Database. The Email Filter may route the email message based on the response. Such routing may include delivering the email message to a Recipient, delivering the email message to a Quarantine Mailbox or deleting the email message.

In another embodiment of the process of the present invention a Sender may send an email message and log an email message attributes to an Email Database. An Email Filter may receive the email message. The Email Filter may send a request to a Server with the email message attributes. The Server may obtain a status of the email message attributes from the Email Database. The Email Filter may receive a response from the Server and route the email message based on the status of the email message attributes.

The systems and methods of the present invention will help Internet users to combat various forms of Internet abuse, which may include spamming and phishing.

The above features and advantages of the present invention will be better understood from the following detailed description taken in conjunction with the accompanying drawings.

### BRIEF DESCRIPTION OF THE DRAWINGS

FIG. 1 is a block diagram illustrating an embodiment of a system of the present invention.

FIG. 2 is a block diagram illustrating an embodiment of a system of the present invention. In this embodiment an Email Filter may access an Email Database directly.

FIG. 3 is a flowchart illustrating an embodiment of a method of the present invention.

FIG. 4 is a flowchart illustrating an embodiment of a method of the present invention.

FIG. 5 is a flowchart illustrating an embodiment of a method of the present invention.

### DETAILED DESCRIPTION AND PREFERRED EMBODIMENT

The present invention will now be discussed in detail with regard to the attached drawing figures which were briefly described above. In the following description, numerous specific details are set forth illustrating the Applicant's best mode for practicing the invention and enabling one of ordinary skill in the art of making and using the invention. It will be obvious, however, to one skilled in the art that the present invention may be practiced without many of these specific details. In other instances, well-known machines and method steps have not been described in particular detail in order to avoid unnecessarily obscuring the present invention. Unless otherwise indicated, like parts and method steps are referred to with like reference numerals.

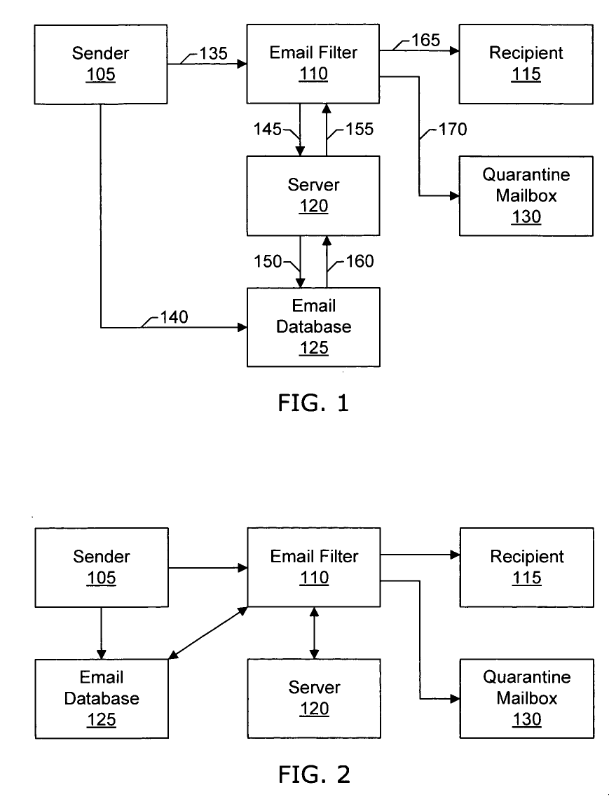

Referring to FIG. 1, an exemplary embodiment of the system of the present invention may include a Sender 105, a Recipient 115, an Email Filter 110, a Server 120, and an Email Database 125. The system may further include a Quarantine Mailbox 130. The Sender 105 is a person or a technological means that sends an email message to the Recipient 115. The Recipient 115 is a person or a technological means that has the ability to receive the email message. The email message may travel via communication links 135 and 165. The communication links 135 and 165 may be a part of a computer network, such as the Internet.

The Server 120 is a computing means connected to a computer network. The Server 120 may assist the Email Filter 110 to access data in the Email Database 125. The Server 120 may also be a Domain Name System (DNS) server or an email server. The Email Database 125 is a storing means connected to a computer network.

The Email Filter 110 is situated between the Sender 105 and the Recipient 115 and has the ability to filter email messages. The Email Filter 110 may be located at the Recipient's client level, at the Recipient's mail server level, at a network gateway, or at the Mail Transfer Agent (MTA) level. The Email Filter 110 may be a computer program, a computer device, or a combination thereof.

When the Sender 105 sends the email message to the Recipient 115, the Sender 105 may log (save, store, forward, post) email message attributes to the Email Database 125 via a communication link 140. The communication link 140 may be a part of a computer network, such as the Internet. The communication link 140 may be secure (e.g. encrypted). Alternatively, the Sender 105 may log the email message attributes to the Email Database 125 through the Server 120. The Email Database 125 and/or the Server 120 may require the Sender 105 to be authenticated prior to logging the email message attributes. The Sender 105 may be authenticated using a login and a password. Alternatively, the Email Database 125 and/or the Server 120 may verify an IP address of the Sender 105. If the IP address is known to be used by the Sender 105, the Email Database 125 and/or the Server 120 may allow the Sender 105 to log the email message attributes.

The email message attributes is data that may be used to identify the email message. The email message attributes may include: the entire email message, the email message headers, the date and time the message was sent, the email message ID, the Recipient's email address, the Sender's email address, the decryption key, the checksum of the message or its parts, hash value of the message or its parts, any other value derived from the message or its parts, or any combination thereof. The Sender 105 may log the email message attributes simultaneously, before, or after sending out the email message.

When the email message is received by the Email Filter 110, the Email Filter 110 may determine a domain name where the email message originated from. The domain name may be determined from the Sender's email address. Then the Email Filter 110 may access a Server 120 associated with the domain name. The Email Filter 110 may send a request, providing the email message attributes, to the Server 120 via communication link 145. The Server 120 may query the Email Database 125 with the email message attributes via communication link 150. The Email Database 125 may return a response to the Server 120 via communication link 160. The response may provide the information necessary to determine whether or not the email message with the specified attributes was logged into the Email Database 125. The Server 120 may forward the response to the Email Filter 110 via communication link 155. The communication links 145, 150, 155, and 160 may be a part of a computer network, such as the Internet. Optionally, the Server 120 and the Email Database 125 may reside on the same physical server.

In an alternative embodiment, the response from the Email Database 125 may provide more details about the status of the email message attributes. Such details may include: information that the email message was delivered to the Email Filter 110 or to the Recipient 115, information about times and originating network locations of requests about the email message (history of requests), information about a partial match between the email message attributes logged in the Email Database 125 and the email message attributes that came with the request/query, etc. An example of a partial match between the attributes may include matching message IDs and different date and time fields.

After the Email Filter 110 receives the response from the Server 120, the Email Filter 110 may determine how to route (divert, process, deliver, dispose) the email message. Typically, if the response indicates that the email message attributes were logged in the Email Database 125, the email message will be delivered to the Recipient 115 or go through additional email filtering procedures (e.g. email black lists). If the email message attributes were not logged in the Email Database 125, the Email Filter 110 may delete the message or forward it to the Quarantine Mailbox 130 via communication link 170. The communication link 170 may be a part of a computer network, such as the Internet. The messages in the Quarantine Mailbox 130 may be reviewed by the Recipient 115 manually or may await until the Sender 105 logs the email message attributes into the Email Database 125 and then may be reevaluated. If the email message attributes were logged into the Email Database 125, the email message may be removed from the Quarantine Mailbox 130 and delivered to the Recipient 115.

Alternatively, the Email Filter 110 may delay transmitting of the email message if the email message attributes were not logged in the Email Database 125. If the Sender 105 first sends the email message and then logs the email message attributes into the Email Database 125, it is possible that the Email Filter 110 may check for the email message attributes prior to the Sender 105 logging the attributes into the Email Database 125. The chance that the email message attributes are not logged into the Email Database 125 may be even higher if the Email Filter 110 is located at the Mail Transfer Agent (MTA) level. If the email message attributes are not logged, the Email Filter 110 may delay transmitting of the email message and check periodically (e.g. every 5, 10, 15 minutes, etc.) if the email message attributes become logged in the Email Database 125. If the email message attributes are not logged within a predetermined time interval (e.g. 1 hour, 2 hours, etc.), the Email Filter 110 may delete the email message. Having the Email Filter 110 located at the MTA level may reduce the amount of network traffic related to transmission of spam messages.

Alternatively, the Email Filter 110 may notify the Server 120 or the Email Database 125 that the email message is pending transmission at the Email Filter 110. When and if the email message attributes are logged, the Server 120 or the Email Database 125 may notify the Email Filter 110 that attributes are logged and the Email Filter 110 may transmit the email message to the next node or destination. If the Email Filter 110 does not receive such notification from the Server 120 or the Email Database 125 within the predetermined time interval, the Email Filter 110 may delete the email message.

The email message attributes in the Email Database 125 may be deleted after the message was delivered to the Recipient 115 or after a predetermined time interval (e.g. 1 day, 2 days, etc.) has expired. This would allow the freeing up of resources in the Email Database 125. If the request for verifying the email message attributes came from the last Email Filter 110 and no more requests are expected, then the Email Database 125 may delete the email message attributes for the verified message. Typically, the Email Database 125 would analyze IP addresses of the requests to determine if the message may be deleted.

It is possible that a perpetrator may obtain the email message sent from the Sender 105 to the Recipient 115. If the perpetrator tries to impersonate the Sender 105, the perpetrator would send an email message that appears originating from the Sender 105 and matches the email message attributes logged by the Sender 105 into the Email Database 125. To prevent this, the email message attributes may comprise values which are hard or impossible to reproduce. For example, a hash value of the perpetrator's email message would be different if the perpetrator changes a single character in the original email message. Also, the email message attributes in the Email Database 125 may be deleted or a record associated with the email message may be marked as “message received” after the email message was delivered to the Recipient 115 so that the perpetrator would not be able to reuse the email message attributes.

The Sender 105 may add a unique code (number, ID, etc.) to the email message, possibly in the headers section of the message. Having the unique code for each email message would allow easy (and unique) reference to the message in the Email Database 125.

An alternative embodiment of a system of the present invention is shown in FIG. 2. In this embodiment the Email Filter 110 may access the Email Database 125 directly. After receiving the email message and determining the domain name, the Email Filter 110 may access the Server 120. The Server 120 may hold information on whether the domain name supports email verification as previously described. If the Server 120 indicates that the domain name supports email verification, the Server 120 may provide the Email Filter 110 with the network location of the Email Database 125. The Email Filter 110 may further access the Email Database 125 without assistance from the Server 120. The network location of the Email Database 125 may be an IP address, a DNS address, a URL, etc. The information about support of the email verification by the domain name as described in this patent application and/or the information about the network location of the Email Database 125 may be stored at the DNS records of the domain name.

In another embodiment the Email Database 125 may be maintained by a trusted entity. In this scenario, the network location of the Email Database 125 may be known to the Email Filter 110. Thus, the need for the Server 120 may be eliminated.

Further, the systems of FIGS. 1 and 2 may comprise multiple Senders 105, multiple Recipients 115, multiple Email Filters 110, multiple Servers 120, multiple Email Databases 125, and/or multiple Quarantine Mailboxes 130. The systems may process/filter one or more email messages.

The systems of FIGS. 1 and 2 may be implemented as subsystems of comprehensive electronic mail systems or spam filtering systems. Such comprehensive spam filtering systems may also include white/black lists filtering, keywords filtering, probability filtering, email address and IP filtering, etc.

The systems may be further used for email delivery confirmation. Because the Email Filter 110 posts requests to the Email Database 125 when the email message is received, such requests may serve as a delivery confirmation notice. The Server 120 or the Email Database 125 may notify the Sender 105 that the email message was received at least at the Email Filter 110 level.

Additionally, the systems may be used for encryption of email messages. The Sender 105 may encrypt the message and log a decryption key into the Email Database 125. The Email Filter 110, preferably located at the Recipient's client level, may decrypt the message by obtaining the decryption key from the Email Database 125 and deliver the message to the Recipient 115.

The systems may further enforce integrity of email messages. The email message may be corrupted due to technical problems or altered intentionally by a perpetrator. If the message is corrupted or altered, some of the email message attributes may differ. For example hash value of the corrupted or altered message and the original message will be different. The Sender 105 may resend the message if it was corrupted or altered.

The systems may allow the Sender 105 to send messages from any network location and through any ISP or email server, as long as the Sender 105 logs the email message attributes into the Email Database 125. Alternatively, the Sender 105 may send email messages through the Server 120 and the Server 120 may log the email message attributes into the Email Database 125. If the Sender 105 sends email messages through the Server 120, the Server 120 may encrypt the messages and log the decryption keys into the Email Database 125. Also the Server 120 may add a unique code to the email message for easy reference by the Email Database 125.

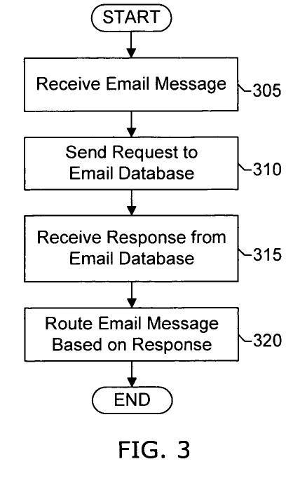

FIG. 3 illustrates an embodiment of a process of the present invention. An Email Filter may receive an email message (Step 305). The Email Filter may send a request to a Server providing email message attributes (Step 310). The Email Filter may receive a response from the Server (Step 315). The Email Filter may route the email message based on the response (Step 320).

The Email Filter may be located at the recipient's client level, at the recipient's mail server level, at the network gateway, or at the Mail Transfer Agent (MTA). The Email Filter may determine the originating domain name from the Sender's email address. For example, if the email message came purportedly from somebody@yahoo.com, then the originating domain name for this message is yahoo.com. The network location of the Server may be determined through DNS records for the domain name. Typically, if the Server's response indicates that the email message did not originate from the domain name, the email message will be deleted.

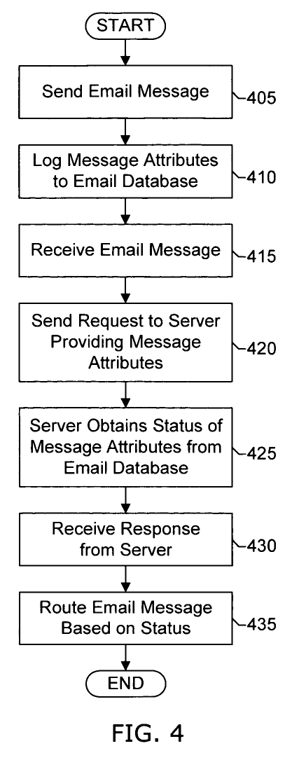

Referring to FIG. 4, a Sender may send an email message (Step 405) and the email message attributes may be logged to an Email Database (Step 410). Steps 405 and 410 may be performed simultaneously or in any order. An Email Filter may receive the email message (Step 415). The Email Filter may send a request to a Server providing the email message attributes (Step 420). The Server may obtain the status of the email message attributes from the Email Database (e.g. verify if the email message attributes are present in the Email Database) (Step 425). The Server may respond to the Email Filter providing the status of the email message attributes in the Email Database (Step 430). The Email Filter may route the email message based on the response from the Server (the status of the email message attributes) (Step 435).

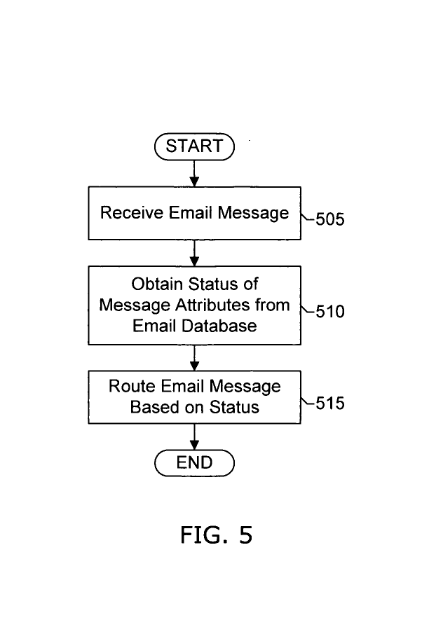

FIG. 5 shows an alternative embodiment of a process of the present invention. An Email Filter may receive an email message (Step 505). The Email Filter may obtain a status of email message attributes from an Email Database (Step 510). The Email Filter may route the email message based on the status (Step 515).

An additional advantage of the described systems and methods is that the source of the email message may be pinpointed to an individual email address, as opposed to other systems and methods that are able to pinpoint the email message only to a domain name or an IP address.

U.S. Patent Application No. 10418006 entitled “A Mail Server Probability Spam Filter” filed on Apr. 17, 2003 is hereby incorporated in its entirety by reference.

U.S. Patent Application No. 10977373 entitled “Tracking Domain Name Related Reputation” filed on Oct. 29, 2004 is hereby incorporated in its entirety by reference.

U.S. Patent Application No. 1011630 entitled “Email Filtering System and Method” filed on Dec. 14, 2004 is hereby incorporated in its entirety by reference.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and is in no way intended for defining, determining, or limiting the present invention or any of its embodiments.

The invention claimed is:

1. An electronic mail system, comprising:
a) a Sender, having an ability to send an email message,
b) an Email Database, wherein said Sender having an ability to store an email message attribute for said email message in said Email Database,
c) a Recipient, having an ability to receive said email message, and
d) an Email Filter, having an ability to intercept said email message sent from said Sender to said Recipient, having an ability to obtain a status of said email message attribute from said Email Database, and having an ability to route said email message based on said status.

2. The system of claim 1, wherein said status indicates that said email message was delivered to said Recipient.

3. The system of claim 1, wherein said status indicates a partial match between email message attributes stored in said Email Database and email message attributes used for obtaining said status.

4. The system of claim 1, wherein said email message attribute is deleted after said email message was delivered to said Recipient.

5. The system of claim 1, wherein said email message attribute is deleted after said email message was delivered to said Email Filter.

6. The system of claim 1, wherein said email message attribute is deleted after a predetermined time interval.

7. The system of claim 1, wherein said Email Filter includes an ability to delay transmitting of said email message and includes an ability to periodically obtain said status of said email message attribute from said Email Database.

8. The system of claim 1, wherein said Email Filter includes an ability to notify said Email Database that said email message is delayed at said Email Filter and awaits verification from said Email Database.

9. The system of claim 1, wherein said obtaining said status of said email message attribute from said Email Database serves as a delivery confirmation notice.

10. The system of claim 1, wherein said Email Filter includes an ability to determine a domain name where said email message purportedly originated from.

11. The system of claim 10, further comprising:
e) a Server, associated with said domain name.

12. The system of claim 11, wherein said Sender includes an ability to send said email message through said Server.

13. The system of claim 11, wherein said Sender includes an ability to store said email message attribute in said Email Database through said Server.

14. The system of claim 11, wherein said Email Filter includes an ability to notify said Server that said email message is delayed at said Email Filter and awaits verification from said Server.

15. The system of claim 11, wherein said Server includes an ability to provide information about said domain name supporting email verification.

16. The system of claim 11, wherein said Server includes an ability to provide information about a network location of said Email Database.

17. A method, comprising the steps of:
a) sending an email message and logging an email message attribute for said email message to an Email Database,
b) receiving said email message,
c) sending a request to a Server providing said email message attribute,
d) said Server obtaining a status of said email message attribute from said Email Database,
e) receiving a response from said Server indicating said status, and
f) routing said email message based on said status.

18. The method of claim 17, wherein said sending said email message and said logging said email message attribute are performed simultaneously.

19. The method of claim 17, wherein Step a) comprising:
g) sending said email message, and
h) logging said email message attribute.

20. The method of claim 17, wherein Step a) comprising:
g) logging said email message attribute, and
h) sending said email message.
